(19) United States
(12) Patent Application Publication
(10) Pub. No.: US 2003/0037981 A1
(43) Pub. Date: Feb. 27, 2003

(54) Method and apparatus for maintaining a connection between a vehicle and fuel source

(76) Inventors: Richard Allen Scholer, Farmington Hills, MI (US); Anthony Wayne Renko, New Boston, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(21) Appl. No.: 09/682,354

(22) Filed: Aug. 24, 2001

(51) Int. Cl. B60D 1/28

(52) U.S. Cl. 180/271

(57) ABSTRACT

An apparatus 10 which allows a transmission 18 to be selectively shifted from a parked gear arrangement to another gear arrangement only when the fuel door 13 is closed and the brake pedal 22 is depressed, thereby allowing a parked vehicle 12 to remain stationary as fuel is being delivered to the fuel tank 33.

### BACKGROUND OF INVENTION

1. Field of the Invention

The present invention generally relates to a method and an apparatus for maintaining a connection between a vehicle and a fuel source and more particularly, to a method and an apparatus for causing a vehicle to remain within a parked state until the fuel door is closed, thereby allowing the vehicle to remain stationary as long as it is securely connected to a fuel source.

2. Background of the Invention

Typically, a “non-electrically powered” vehicle includes a tank which selectively receives fuel and which stores the fuel until it is communicated to and used by a torque generator, such as and without limitation an internal combustion engine.

More particularly, this type of vehicle normally includes a generally hollow pipe or conduit (a vehicular fuel reception conduit) having a first end which is physically and communicatively coupled to the fuel tank and a second open end which allows the received fuel to be communicated into the fuel tank. Particularly, the second open end typically receives a selectively removable fuel cap which prevents contaminants from entering the fuel tank. The vehicle further and typically includes a fuel door which is selectively movable between a first closed position in which the fuel door overlays the second open end of the vehicular fuel reception conduit and the fuel cap, and a second open position in which the fuel cap is exposed, effective to allow the fuel cap to be removed and to allow for the second open end of the vehicular fuel reception conduit to be selectively and communicatively coupled to a source of fuel or energy. While there exist a wide variety of connection arrangements or configurations which allow the provided fuel to be communicated into the fuel tank, each of these arrangements require the vehicle to remain substantially stationary while receiving fuel.

For example, a gasoline fuel source or pump typically includes a conduit or hose which is removably placed within and which is received by the vehicular fuel reception conduit. The hose and the vehicular fuel reception conduit therefore cooperate in order to allow the gasoline to be selectively placed within the vehicular fuel tank. In contrast to this gasoline coupling configuration, a hydrogen fuel source is typically and mechanically locked onto the vehicular fuel reception conduit (or other portion of the vehicle) while hydrogen fuel is being communicated to the fuel tank in order to ensure that an integral connection is created and maintained, thereby reducing the likelihood of fuel leakage.

It is not desirable to move the vehicle while it is coupled to the fuel source because such movement may break the fuel connection and cause damage to the fuel source and to the vehicle, especially if the fuel source is locked onto the vehicular fuel reception conduit. In order to reduce the likelihood of such undesirable movement, various configurations exist which disable the vehicle (i.e., prevent the vehicle from moving) in the event that the fuel door is opened, which is indicative of fuel being delivered to the vehicle's fuel tank. Particularly, these configurations interrupt the transfer of torque from the engine (or from some other torque generator) to the wheels when the fuel door is opened, thereby disabling the vehicle (e.g., preventing movement of the vehicle).

### SUMMARY OF INVENTION

The present invention provides a method and an apparatus for keeping a vehicle stationary without having to interrupt the torque which is communicated to the wheels of the vehicle.

A first non-limiting aspect of the present invention is an apparatus having a first portion that senses the movement of a certain portion of a vehicle; and a second portion which causes the vehicle to be stationary in response to the sensed movement only if the vehicle was stationary as the movement was sensed.

A second non-limiting aspect of the present invention is a vehicle having a movable fuel door and a transmission assembly which may be selectively shifted from a parked gear arrangement to another gear arrangement; a selectively movable shifting member which is coupled to the transmission assembly; and an assembly which is coupled to the selectively movable shifting member and to the transmission assembly, which senses the movement of the fuel door, and which causes the shifting member to maintain a certain position in response to the sensed movement of the fuel door, thereby preventing the transmission from being moved from the parked gear arrangement.

A third non-limiting aspect of the present invention is a method for operating a vehicle of the type having a selectively movable fuel door and a selectively shiftable transmission assembly. The method includes the steps of sensing the position of the fuel door; and preventing the shifting of the transmission when the fuel door is in a certain position.

The following detailed description and drawings describe a preferred embodiment of the invention.

### BRIEF DESCRIPTION OF DRAWINGS

FIG. 1 is a block diagram of an apparatus which is made in accordance with the teachings of the preferred embodiment of the invention and shown being operatively disposed within a vehicle.

FIG. 2 is a schematic diagram of the apparatus of the preferred embodiment of the invention in combination with the shift assembly, which are each shown in FIG. 1.

### DETAILED DESCRIPTION

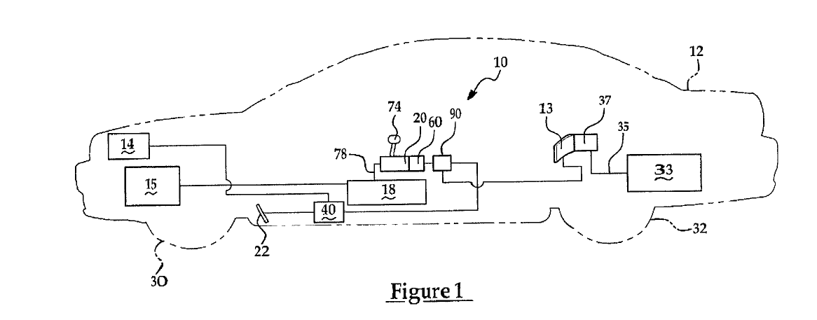

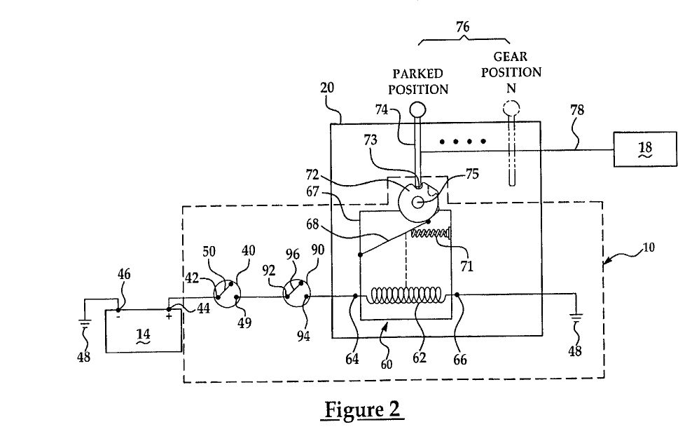

Referring now to FIGS. 1 and 2, there is shown an apparatus 10 which is made in accordance with the teachings of the preferred embodiment of the invention and which is operatively disposed within a vehicle 12.

Particularly, vehicle 12 is of the type having an electrical battery 14, a torque generator 15 (e.g., an internal combustion engine), a transmission assembly 18, a gear or transmission shifting assembly 20, a selectively depressible brake pedal or member 22, a pair of front wheels 30, a pair of rear wheels 32, a selectively movable fuel door 13, a fuel tank 33, and a fuel conduit 35. It should be appreciated that only the relevant portions of the vehicle 12 (such as the shift assembly 20 and the transmission 18) are shown.

As should be appreciated by those of ordinary skill in the art, the transmission assembly 18 is coupled to and receives torque from the torque generator 15 and communicates at least a portion of the received torque to the front wheels 30 (in a front wheel drive configuration), the rear wheels 32 (in a rear wheel drive configuration), or to both sets of wheels 30, 32 (in an all wheel drive configuration). Shifting assembly 20 includes a movable member 74 which may selectively occupy certain predetermined positions 76, each of which correspond to a unique transmission gear position.

The shifting assembly 20 is coupled to the transmission 18 by member/assembly or bus 78 and the movement of the assembly 20 causes the transmission 18 to move or shift from one gear arrangement to another. That is, as should be appreciated by those of ordinary skill in the art, portion 18 may comprise a bus which receives a signal from the shifting assembly 20 indicating the occurrence of a shifting type movement of member 74 and causes this signal to be communicated to a controller (not shown) which causes the desired shifting to occur within the transmission 18. Alternatively, portion 18 may comprise an assembly which mechanically causes the desired shifting to occur, within the transmission 18, in response to the movement of member 74. Fuel tank 33 is coupled to the conduit 35 and, more particularly, the conduit 35 communicatively couples the interior cavity of the fuel tank 33 with opening 37. The opening 37 is created within/through the body of the vehicle 12 and is selectively covered by the fuel door 13.

As shown best in FIG. 2, the apparatus 10 further includes a brake switch assembly 40 having a first terminal 42 which is coupled to the positive terminal 44 of the battery 14. The negative terminal 46 of the battery 14 is coupled to electrical ground potential 48. Further, the brake switch 40 includes a second terminal 49 and a member 50 which is coupled to the terminal 42 and to the brake pedal 22. Particularly, member 50 is movable, in response to a depression of the brake pedal 22, from a first open position, which is shown in FIG. 2 and in which the member 50 is remote from the terminal 49, to a second closed position in which the member 50 couples the terminal 42 to terminal 49.

The apparatus 10 further includes a second switch 90 which includes a first terminal 92 which is coupled to terminal 49, and a second terminal 94. The switch 90 also includes a member 96 which is movably coupled to the terminal 92 and to the fuel door 13. Particularly, member 96 is movable, in response to an opening of the fuel door 13, from a closed position in which the member 96 couples the terminal 92 to the terminal 94, to an open position, which is shown in FIG. 2, in which the member 96 is remote from the terminal 94. Hence, switches 40, 90 respectively sense the movement of the brake pedal 22 and the fuel door 13.

The apparatus 10 further includes a cam member 72, which may be of any desired shape, and which is movably and pivotally deployed within the shift assembly 20 by axle member 75. Apparatus 10 also includes a solenoid or relay assembly 60 which is enclosed within housing 67. Particularly, housing 67 is disposed within the shifting assembly 20 and cam 72 is received within the housing 67. Relay assembly 60 includes an inductor or electrical coil 62 with a first terminal 64 which is coupled to the terminal 94 and a second terminal 66 which is coupled to the electrical ground potential 48. Solenoid 60 further includes a movable member 68 which is pivotally coupled to the relay housing 67 and which is normally biased against the cam member 72 by spring 71 (which is coupled to housing 67), effective to cause the detent portion 73 of the cam member 72 to engage or receive the member 74 when the member resides within a first parked position, thereby substantially preventing the member 74 from being moved from this first or parked position and thereby preventing the transmission assembly 18 from being shifted from the parked gear state or arrangement.

In operation, the selective depression of the brake member 22 causes member 50 of switch 40 to occupy a closed position which causes electrical power, provided from the battery 14, to be provided to the terminal 49. Closure of the fuel door 13 causes the member 96 to connect the terminal 92 to the terminal 94. Hence, if the fuel door 13 is closed and the brake member 22 is depressed, electrical power is provided by the battery 14 to the terminal 94 (i.e., the electrical power travels from terminal 49 to the terminal 94 through the member 96). The received electrical power is communicated to the inductor 62, through terminal 64, and causes the inductor 62 to generate electric flux energy which causes the locking member 68 to occupy a second released or open position (i.e., to move away from the cam member 72 against the force of the spring 71), thereby allowing the shift assembly 20 to be moved from the parked position to another gear position, effective to allow the vehicle 12 to be moved (e.g., allowing the transmission 18 to be shifted from a parked state to another gear state by the movement of the member 74 of the shift assembly 20).

Thus, in the most preferred embodiment of the invention, the fuel door 13 must be closed and the brake member 22 must be depressed (e.g., the vehicle 12 must be stationary) and in a sensed fueling state in order to allow the transmission assembly 18 to be selectively shifted from the parked state. Thus, assembly 10 causes the vehicle 12 to be stationary or to remain in a parked state only if the sensed movement of the fuel door 13 occurs when the vehicle 12 is in a parked state or is stationary. It should be appreciated that the fueling state (e.g., the state in which fuel is being delivered to the vehicle 12) may be sensed in many ways, such as by a switch which is closed when the fuel conduit is locked unto the vehicle 12 or by a sensor which senses the communication of fuel into the fuel conduit. Such alternate switches/sensors then provides a path from terminal 49 to terminal 64 until the fuel conduit is removed from the vehicle or the flow of fuel causes.

Apparatus 10 may be adapted to only prevent the shifting assembly 20 (and the transmission 18) from exiting the parked gear position or state, while allowing shifting assembly 20 (and the transmission 18) to enter the parked gear position or state from another position or gear state even when the fuel door 13 is open (e.g., an override switch may be used to supply power to the inductor 62 in order to allow the member 74 to be moved into the parked position, a spring 71 may be chosen such that the force exerted by the spring 71 may be overcome by the operator in order to force the member 74 to the parked position, or the path to enter the parked position may not be the same as the path to exit the parked position).

Moreover, it should be appreciated that in a manual transmission type arrangement, the switch 96 may be coupled to a controller (not shown) or another assembly which prevents the torque from being communicated to the wheels 30, 32 when the fuel door 13 is opened. Further, in yet another non-limiting embodiment of the invention, switch assembly 40 may be eliminated.

This disclosure is directed to describing the features and novel aspects of the subject invention for purpose of obtaining a patent monopoly. The present disclosure is not directed to evaluating or promoting the appropriateness of implementing the subject invention in a commercial product. Many factors are involved in a decision to implement a particular feature in a commercial product, and a full evaluation of these factors is beyond the scope of this document.

1. an apparatus which determines whether a vehicle is in a fueling state and which causes the vehicle to be stationary when said vehicle is in a fueling state:

2. The apparatus of claim 1 further comprising a first portion which senses the movement of a portion of a vehicle in order to determine whether said vehicle is in a fueling state; and a second portion which causes said vehicle to be stationary in response to said determination.

3. The apparatus of claim 2 wherein said certain portion comprises a fuel door.

4. The apparatus of claim 3 wherein said first portion comprises a first switch which is movable from a first closed position to a second open position in response to the movement of said fuel door.

5. The apparatus of claim 4 wherein said vehicle is of the type having a shifting assembly and wherein said second portion comprises a relay assembly which is coupled to said first switch; and a movable cam which is coupled to said relay assembly and which prevents said movement of said shifting assembly.

6. The apparatus of claim 5 wherein said cam prevents movement of said shifting assembly from a parked position.

7. The apparatus of claim 6 wherein said relay assembly comprises an inductor; and a member which is normally biased against said cam.

8. The apparatus of claim 7 wherein said vehicle is further of the type having a selectively depressible brake pedal, said apparatus further comprising a second switch which is coupled to said selectively depressible brake pedal and to said first switch and which is effective to allow said shifting assembly to move only when said brake assembly is depressed.

9. The apparatus of claim 8 wherein said first and second switches cooperatively allow said shifting assembly to move from said parked position only when said brake pedal is depressed and said fuel door is closed.

10. The apparatus of claim 1 wherein said apparatus comprises a sensor which senses a flow of fuel into said vehicle; and a second portion which causes said vehicle to be stationary when said sensor senses said flow of fuel.

11. A vehicle comprising a movable fuel door; a transmission assembly which may be selectively shifted from a parked gear arrangement to another gear arrangement; a selectively movable shifting member which is coupled to said transmission assembly; and an assembly which is coupled to said selectively movable shifting member and to said transmission assembly, which senses the movement of said fuel door, and which causes said shifting member to maintain a certain position in response to the sensed movement of said fuel door, thereby preventing the transmission from being shifted from said parked gear arrangement.

12. The vehicle of claim 11 wherein said assembly comprises a switch; a relay assembly which is coupled to said switch; and a cam which is coupled to said relay assembly and to said shifting member.

13. The vehicle of claim 12 wherein said relay assembly comprises an inductor; and a selectively movable member which is biased against said cam.

14. The vehicle of claim 13 wherein said cam includes a detent portion which receives said shifting member.

15. The vehicle of claim 13 further comprising a selectively depressible brake pedal; and a second switch which is coupled to said brake pedal and to said assembly and which is effective to cause said shifting member to maintain said certain position when said brake is released.

16. The vehicle of claim 15 wherein said switch and said second switch cooperatively allow said shifting member to be moved from a certain position only when said brake pedal is depressed and said fuel door is closed.

17. The vehicle of claim 11 wherein said movement of said fuel door comprises an opening of said fuel door.

18. A method for operating a vehicle of the type having a selectively movable fuel door and a selectively shiftable transmission assembly, said method comprising the steps of sensing movement of said fuel door; and preventing the shifting of said transmission assembly when said fuel door is in a certain position.

19. The method of claim 16 wherein said certain position comprises an open position.

20. The method of claim 16 wherein said vehicle further includes a selectively depressible brake pedal and wherein said method further comprises the step of allowing said shifting of said transmission assembly only when said brake assembly has been depressed.
